(19) United States
(12) Patent Application Publication
(10) Pub. No.: US 2023/0160121 A1
(43) Pub. Date: May 25, 2023

(54) SINGLE LAYERED GARMENT FABRIC

(71) Applicant: InQube Solutions (Private) Limited, South Ranala (LK)

(72) Inventors: Nilanka Lakman GURUGE, South Ranala (LK); Hayley OWENS, South Ranala (LK); Pulukkuttige Don Resitha SOMASIRI, South Ranala (LK); Moraliyage Don Sisira Dimuthu PRIYANKARA, South Ranala (LK)

(21) Appl. No.: 17/794,775

(22) PCT Filed: Jan. 15, 2021
(86) PCT No.: PCT/IB2021/050309

§ 371 Date: Jul. 22, 2022

Related U.S. Application Data
(60) Provisional application No. 62/965,590, filed on Jan. 24, 2020.

(51) Int. Cl. D06C 7/00; D04B 1/24; D04B 1/18; D04B 1/10; B29C 43/00; B29C 43/52; B29C 43/02; A41C 5/00

(52) U.S. Cl. CPC D06C 7/00; D04B 1/246; D04B 1/18; D04B 1/102; B29C 43/003; B29C 43/52; B29C 43/02; A41C 5/005; D10B 2501/02; D10B 2401/041; B29L 2031/4885

(57) ABSTRACT

Various textile materials and method of manufacturing the same are provide. A method of single layer garment includes providing a single layer of textile material with low melt yarn. The method also includes forming the structure of the single layer of textile 5 material using selective heating to provide material support. The textile material are formed via at least one of a molding machine or a robotic hot air machine.

### TECHNOLOGICAL FIELD

An example embodiment relates generally to manufacturing fabric, and more particularly, example embodiments relate to manufacturing single layered fabric.

### BACKGROUND

Modern engineered textiles used in garments, such as bra garments are defined by the one or more measurable functional attributes of performance. In various embodiments, delivering high performance textiles materials across multiple measurable functional attributes may be difficult. As the requirements of these attributes increased the complexity and the negative attributes increased due to complex assembly techniques or the contrasting nature of the attributes could not be produced harmoniously to coexist on the same garments. Through applied effort, ingenuity, and innovation, many of these identified problems have been solved by developing solutions that are included in embodiments of the present disclosure, many examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a method of manufacturing a single layer garment is provided. The method may include providing a single layer of textile material with low melt yarn. The method may also include forming the structure of the single layer of textile material using selective heating to provide material support.

In some embodiments, the textile material are formed via at least one of a molding machine or a robotic hot air machine. In some embodiments, the forming of the textile material via the molding machine includes removably attaching the textile material to a bottom plate, wherein the bottom plate is configured with one or more bottom plate inserts configured to receive the textile material; cold molding the textile material, wherein the cold molding creates the three dimensional profile of the garment; and selective heat molding the textile material based on the function of the garment. In such an embodiment, the selectively heated portions of the textile material provide at least one of fit or support to the garment. In some embodiments, the textile material is removably attached to the bottom plate via clamps or pins. In some embodiments, the bottom plate includes a suction bed configured to pull the textile material into the bottom plate mold. In some embodiments, the cold molding takes place in an automated chilling unit. In some embodiments, the selective heat molding the textile material based on the function of the garment include engaging a top plate configured with one or more heated portions with the textile material. In such an embodiment, the textile material is positioned between the top plate and bottom plate during the hot molding process.

In some embodiments, the forming of the textile material via the hot air machine includes removably attaching the textile material to a bottom plate. In such an embodiment, the bottom plate is configured with one or more bottom plate inserts configured to receive the textile material. In some embodiments, the forming of the textile material via the hot air machine also includes selective heat molding the textile material based on the function of the garment. In such an embodiment, the selectively heated portions of the textile material provide support to the garment. In some embodiments, the forming of the textile material via the hot air machine further includes curing the textile material on a mold.

In some embodiments, the textile material is removably attached to the bottom plate via clamps or pins. In some embodiments, the selective heat molding the textile material based on the function of the garment includes applying hot air, via a hot air nozzle, to specific portions of the textile material. In some embodiments, the hot air nozzle is operatively coupled to a hot air movable head and the hot air moveable head is configured to move in at least one of an x direction, a y direction, a z direction, or rotationally. In some embodiments, at least one of the hot air nozzle size or the air flow is adjustable. In some embodiments, the method also includes cutting the garment into a final pattern after the textile material is selectively heated. In some embodiments, the textile material further includes a textile yarn and a stretch yarn. In some embodiments, the textile material is a jacquard material. In some embodiments, the selective heat is between the melting point of the low melt yarn and the non-low melt yarn. The manufactured textile material is also provided herein.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIGS. 1A and 1B illustrate two example textile materials made using a Jacquard knit in accordance with an example embodiment of the present disclosure;

FIG. 2 illustrates an example bra garment with varying zones based on the desired shape and function of the bra garment in accordance with an example embodiment of the present disclosure;

FIG. 3 is a flow chart showing the operation of an example embodiment for manufacturing a single layer garment in accordance with an example embodiment of the present disclosure;

FIG. 4A is a flow chart of the operations of forming the structure of the single layer of textile material using selective heating to provide material support in an instance in which a molding machine is used in accordance with an example embodiment of the present disclosure;

FIG. 4B is a flow chart of the operations of forming the structure of the single layer of textile material using selective heating to provide material support in an instance in which a hot air machine is used in accordance with an example embodiment of the present disclosure;

FIG. 5A-F are various components of a molding machine for use in various embodiments of the present disclosure;

FIG. 6 illustrates the hot air machine of an example embodiment of the present disclosure; and

FIG. 7 illustrates the heated portions of a bra garment in accordance with an example embodiment of the present disclosure.

### DETAILED DESCRIPTION

The present disclosure now will be described more fully hereinafter with reference to the accompanying drawings in which some but not all embodiments are shown. Indeed, these various embodiments of the disclosure may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

The components illustrated in the figures represent components that may or may not be present in various embodiments of the disclosure described herein such that embodiments may include fewer or more components than those shown in the figures while not departing from the scope of the disclosure. Some components may be omitted from one or more figures or shown in dashed line for visibility of the underlying components.

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of the stated features, steps, operations, elements, and/or components, but do not prelude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so denied herein.

The present disclosure is to be considered as an exemplification of the various embodiments and is not intended to limit the disclosure to the specific embodiments illustrated by the figures or description below. While various embodiments discussed herein are directed at an adjustable bra garment, the present disclosure may also apply to other garments.

Overview

Performance apparel is a segment of apparel which has seen continuous growth in the last decade due to changes in lifestyles in major markets including pants, jackets, bras, tops, t-shirts, etc. Such engineered textiles are defined by the one or more measurable functional attributes of performance which helps consumers obtain an advantage against a non-performance apparel.

As the requirements of these attributes has increased, the complexity and the negative attributes increased due to complex assembly techniques and/or the contrasting nature of the attributes not being capable of being produced harmoniously on the same garments. Therefore, complex assembly has been required including using multiple fabrics with various attributes and varying degrees of functional aspects of stability, support and compression required. Additional processes, such as printing or sewing or bonding may also be used, to obtain the desired attributes.

Engineered knit textiles and textiles composites help to alleviate some of these issues, but engineered knits due to inherent stretch could not provide stable support and composites compromised fit and comfort due to non-stretch or low stretch behavior
Various embodiments of the present disclosure, due to its unique yarn blend and the heating process, has created a single layer fabric, which has high stretch and stable locked out zones side by side without compromising comfort, fit, and moisture management properties in a single layer. Various embodiments allow for ultra-high-performance apparel from a single layer of fabric with stable support, compression, fit, and comfort, while having moisture management in all areas of the garment. For example, as discussed herein, a single layer customized support (low medium or high) sports bra can be made from a single layer of fabric with a stable locked out area localized to any area of the bra as appropriate (e.g., front, cradle, sides, back, straps, etc.) with encapsulating three-dimensional shaping, while the rest of the areas can have high stretch. Such garment may also the retain moisture management properties in all areas of the garment. For example, the moisture management may be achieved in the heated area based on a diffusion or a diffusion and capillary action in combination based on the heat process applied.

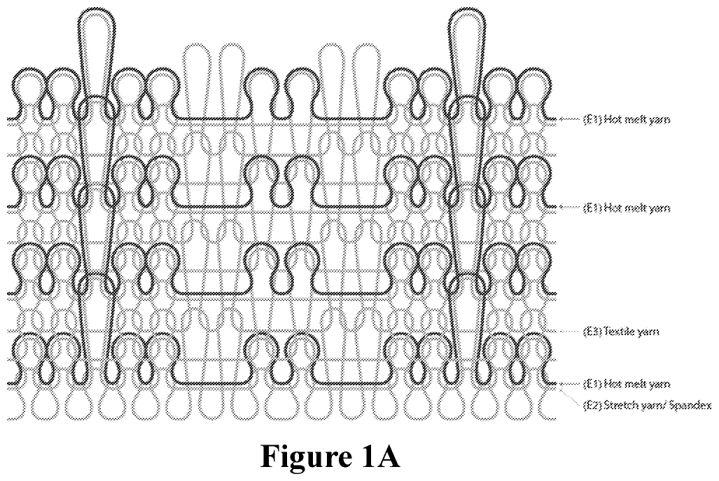

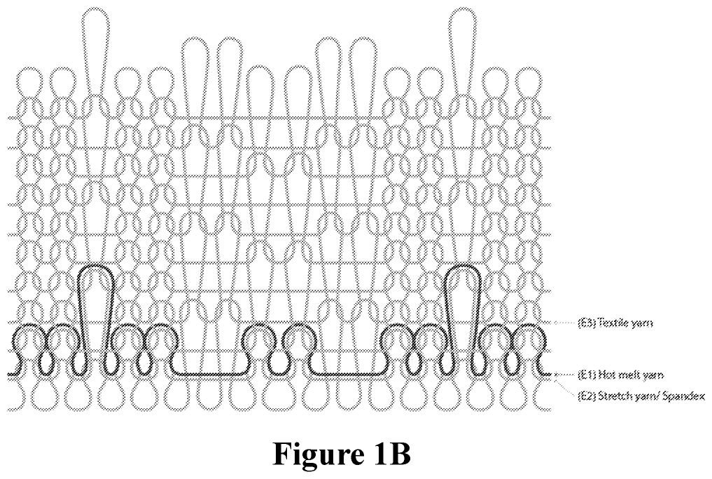

FIGS. 1A and 1B illustrate example textile materials (e.g., a Jacquard weave) used in various operations discussed herein. In some embodiments, Jacquard materials may have a wide range of structures, materials, and properties. As such Jacquard materials may be used in a variety of products. As examples, knit components may be utilized in apparel (e.g., shirts, pants, socks, jackets, undergarments, footwear), athletic equipment (e.g., golf bags, baseball and football gloves, soccer ball restriction structures), containers (e.g., backpacks, bags), and upholstery for furniture (e.g., chairs, couches, car seats). Various textile materials, such as knit components, may also be used in bed coverings (e.g., sheets, blankets), table coverings, towels, flags, tents, sails, and parachutes. Additionally, knit components may be used as technical textiles for industrial purposes, including structures for automotive and aerospace applications, filter materials, medical textiles (e.g., bandages, swabs, implants), geotextiles for reinforcing embankments, geotextiles for crop protection, and industrial apparel that protects or insulates against heat and radiation. Accordingly, knit components may be incorporated into a variety of products for both personal and industrial purposes.

Various embodiments discussed herein may use a Jacquard structure of single layer-integrated Textile material. As shown in FIGS. 1A and 1B, in various embodiments, the textile material may have a combination of low temperature melt yarns E1, standard textile yarn E3, and high tenacity yarn E2 (e.g., stretch yarn). For example, the low temperature melt yarn may be a thermoplastic nylon, polyester, and/or polyurethane material. In some embodiments, the standard textile yarn may be a spun or filament yarn of natural or synthetic origin. In some embodiments, the high tenacity yarn may be a yarn with tenacity higher than 60 centinewtons per tex (cN/Tex), in some embodiments spandex or Elastane stretch yarn can be of polyester urethane or polyether urethane. In various embodiments, the textile material may be configured to be customized to create fully locked, partially locked, as well as high stretch/low stretch support compression zones with moisture management property in an instance in which the textile material is heat processed. In some embodiments, the processes discussed herein may create engineered jacquard garments with customized fit and performance. In various embodiments, the configuration of the Jacquard material may affect the performance of the textile material. For example, the low-melt yarn E1 may be configured to melt in certain portions of the textile material to provide additional support at said portions. The Jacquard knit shown in FIGS. 1A and 1B are for illustration purpose and may be used in various garments. The knit jacquard patterns are limited by the machine mechanical and patterning software, but may be varied based on the desired structure of the garment. In various embodiments, different machines may differentiate the structure and the technique used to knit in the yarn combination and the result may vary as well (e.g., FIGS. 1A and 1B have the same pattern with different yarn layouts).

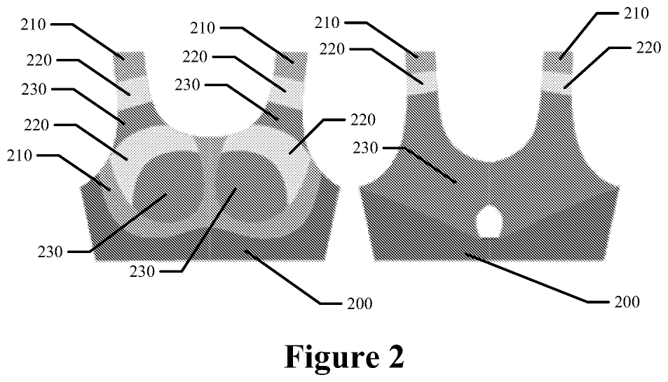

FIG. 2 illustrates an example bra garment with varying zones based on the desired shape and function of the bra garment. As shown in FIG. 2, the elastic module throughout a textile material may vary based on the Jacquard knit. In some embodiments, the shaded area 210 may be a heat locked area of the bra garment. In some embodiments, the shaded area 200 may be a jacquard knit that has been heat locked. In some embodiments, the shaded area 220 and the shaded area 230 may be a jacquard knit that has not been locked out. In various embodiments, the elastic module may be higher in shaded area 210 than in shaded area 200. In various embodiments, the elastic module may be higher in shaded area 200 than in shaded area 220. In various embodiments, the elastic module may be higher in shaded area 220 than in shaded area 230.

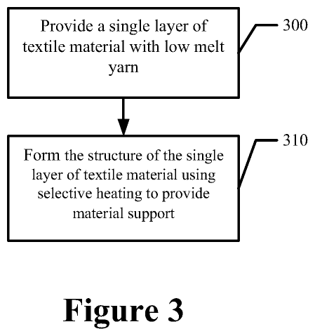

FIG. 3 is a flow chart showing the operation of an example embodiment for manufacturing a single layer garment. Referring now to Block 300 of FIG. 3, the method includes providing a single layer of textile material with low melt yarn. As discussed above in reference to FIGS. 1A and 1B, the textile material may be a Jacquard weave. In various embodiments, the textile material may be a single layer combination of a low melt yarn, a standard textile yarn, Spandex or elastane and a high tenacity yarn. The method may include knitting the textile material with a low-melt yarn and a non-low-melt yarn to locate the melt yarn on middle of the material. In such an embodiment, the low-melt yarn may be able to bond with inner non-low-melt yarns and make required locking effect. In some embodiments, the bonded component may be heated to form a thermal bond between a thermoplastic polymer material of the low-melt yarn and the bonded other inner yarns such as Textile yarn and high tenacity yarn (e.g., stretch yarns).

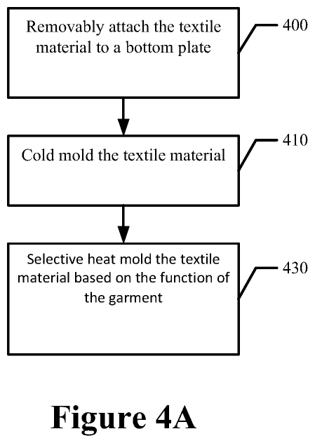

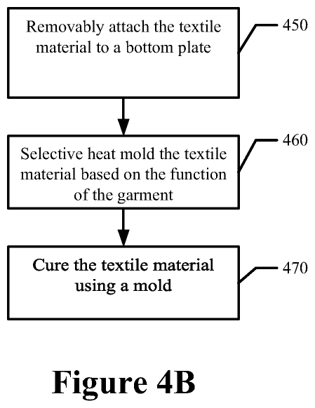

Referring now to Block 310 of FIG. 3, the method also includes forming the structure of the single layer of textile material using selective heating to provide material support. In various embodiments, the structure of the textile material may be formed via at least one of a molding machine or a hot air machine. In an instance in which the textile material is formed via the molding machine, the method of forming the structure are discussed in more detail in reference to FIG. 4A. In an instance in which the textile material is formed via the hot air machine, the operations are discussed in more detail in reference to FIG. 4B. In various embodiments, the selective heat may be between the melting point of the low melt yarn and the non-low melt yarn (e.g., textile yarn and/or high tenacity yarn). In various embodiments, other methods of heating may be used that allows for the heat to be applied to specific areas.

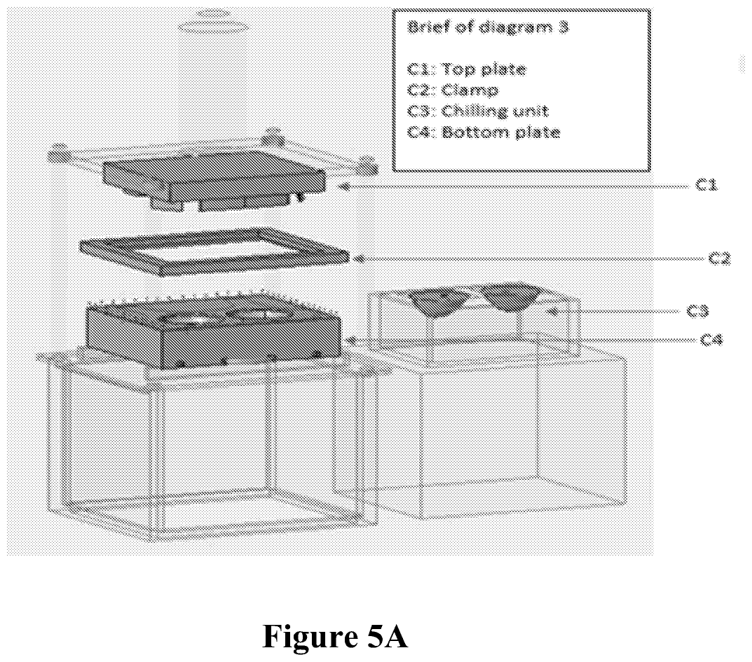

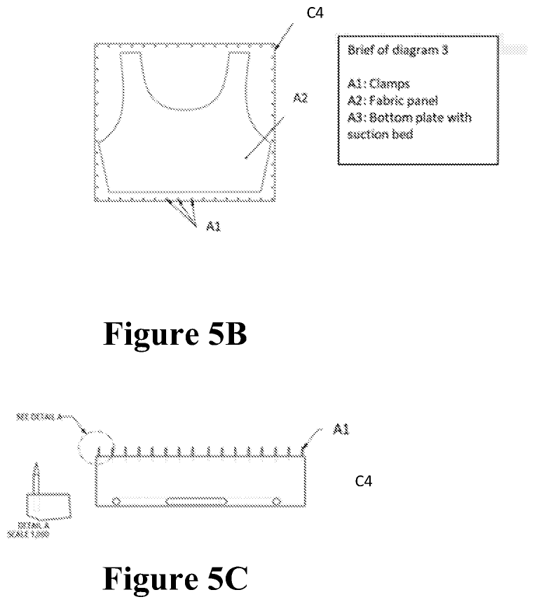

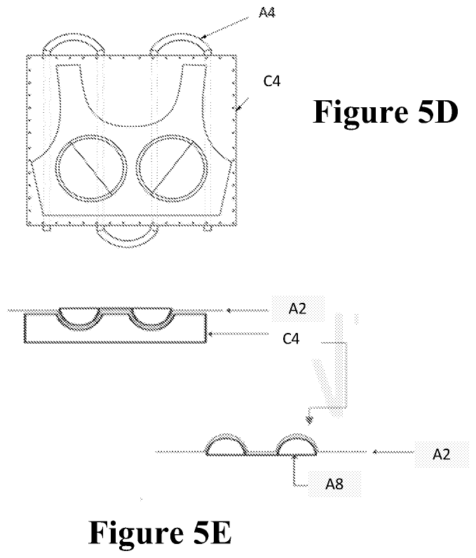

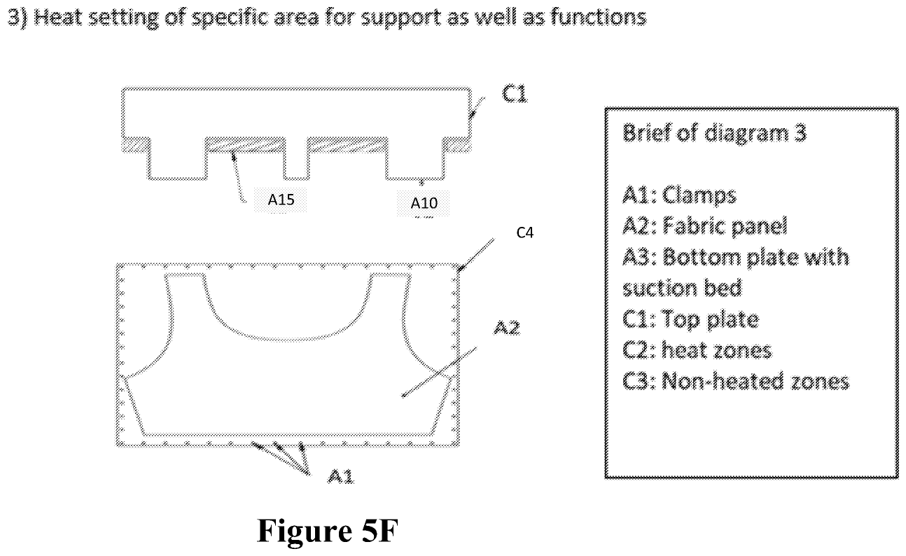

FIG. 4A is a flow chart of the operations of forming the structure of the single layer of textile material using selective heating to provide material support in an instance in which a molding machine is used. FIG. 5A-5F illustrate a molding machine of an example manufacturing method. As shown in FIG. 5A, the molding machine may include a top plate C1, a clamp C2, a chilling unit C3, and a bottom plate C4. In some embodiments, as discussed below in reference to FIG. 5F, the top plate C1 may include one or more heated zones A10 and one or more unheated zones A15 configured to selectively heat the textile material during operation. In various embodiments, the clamp C2 may be configured to engage with the pin A1 of the bottom plate C4 to hold the textile material in place during operation. In some embodiments, the clamp C2 may be two dimensional or three dimensional (e.g., restrict the motion of the textile material in two or three directions). In some embodiments, other attachment methods may be contemplated for the textile material. In some embodiments, the bottom plate C4 may include one or more bottom plate inserts configured with suction beds to pull the textile material into said bottom plate inserts. In some embodiments, the chilling unit C3 may be automated to chill the cold mold A8 (shown in FIG. 5E). In various embodiments, the chilling unit C3 may be approximately at or below room temperature during operation. In various embodiments, during operations, the heat from textile material may need to be absorbed by the cold mold A8 in order for the textile material to experience a lasting (e.g., permanent) molding effect. In various embodiments, the lower temperature of the chilling unit C3 may reduce chilling time and improve productivity of the method.

Referring now to Block 400 of FIG. 4A, the method of forming the structure of the single layer of textile material with a molding machine includes removably attaching the textile material to a bottom plate. In various embodiments, the bottom plate 500 may be configured with one or more bottom plate inserts 510 (shown in FIG. 5) configured to receive the textile material. In some embodiments, the bottom plate 500 may be configured with one or more suction beds configured to pull the textile material into the bottom plate inserts. In some embodiments, the textile material is removably attached to the bottom plate via clamps or pins. FIGS. 5B and 5C show the bottom plate C4 of the molding machine in accordance with an example embodiment. As shown in FIG. 5B, the single layered textile may be placed on the bottom plate C4. For example, the textile material A2 may need to be oriented such that the textile material is positioned on the bottom plate C4. In various embodiments, the bottom plate C4 may have one or more pins A1 configured to engage with a clamp C2 (shown in FIG. 5A). In various embodiments, the pins A1 and clamp C2 may be configured to hold the textile material A2 in place during the operations discussed herein. In various embodiments, the attachment means for holding the textile material A2 into place using may be pins, manual clamp, a clamp using a robotic arm, and/or the like, based on the type of textile material.

Referring now to Block 410 of FIG. 4A, the method of forming the structure of the single layer of textile material with a molding machine includes cold molding the textile material. In some embodiments, the cold molding creates the three-dimensional profile of the garment. In some embodiments, the cold molding takes place in an automated chilling unit. In various embodiments, as shown in FIG. 5D, the bottom plate may be configured with one or more cooling lines, configured to cool the bottom plate, such that the textile material may be cold molded as discussed herein. In some embodiments, the chilling unit C3 may be configured to cool the cold mold A8 shown in FIG. 5D. As such, during the cold molding process, the cold mold A8 may be placed on the textile material A2, such that the textile material A2 is positioned between the cold mold and the bottom plate C4.

Referring now to Block 420 of FIG. 4A, the method of forming the structure of the single layer of textile material with a molding machine includes selective heat molding the textile material based on the function of the garment. In some embodiments, the selectively heated portions of the textile material provide support to the garment. In some embodiments, the selective heat molding the textile material based on the function of the garment includes engaging a top plate configured with one or more heated portions with the textile material. In such an embodiment, the textile material is positioned between the top plate and bottom plate during the hot molding process. As shown in FIG. 5F, the top plate C1 may include both heat zones A10 and non-heated zones A15 configured to selectively provide heat to certain portions of the textile material. In various embodiments, the cold mod A8 may be fixed (e.g., engaged with the textile material) during the selective heating process. In some embodiments, the heated zones may be from approximately 150 degrees Celsius to approximately 180 degrees Celsius. In some embodiments, the hot molding may occur for approximately 30 seconds to approximately 60 seconds (e.g., the heated zones may be engaged with the textile material for 30 second to 60 seconds). In various embodiments, the pressure of the top plate C1 on the textile material may be from approximately 4 bars to 6 bars. In various embodiments, the textile material A2 may be removed from the molding machine upon completion and allowed to cure before being cut into the desired garment shape.

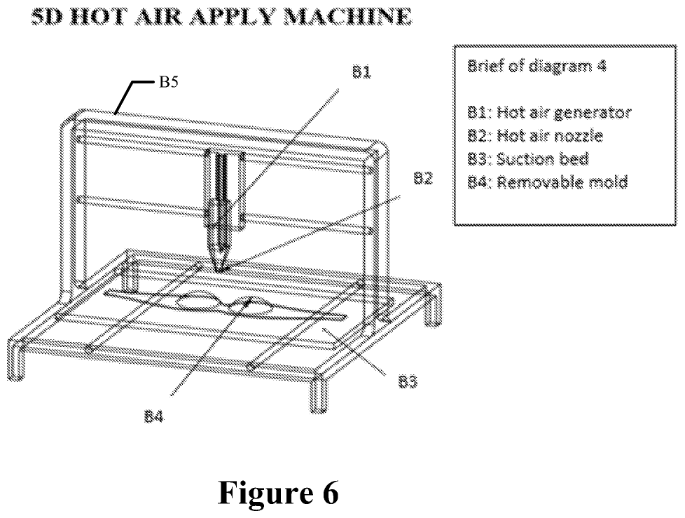

FIG. 4B is a flow chart of the operations of forming the structure of the single layer of textile material using selective heating to provide material support in an instance in which a hot air machine is used. FIG. 6 illustrates the hot air machine of an example manufacturing method discussed herein. As shown in FIG. 6, in some embodiments, the hot air machine 600 may include a hot air mechanism (e.g., a hot air generator B1 configured with a hot air nozzle B2 attached to a moveable hot air arm), a bottom plate (e.g., a suction bed) B3, and a removeable mold B4. In various embodiments, the hot air mechanism may include a frame B5 configured to support the hot air generator B1 and hot air nozzle B2 during operation. In some embodiments, the hot air nozzle B2 may be operatively coupled to a hot air movable head. In some embodiments, the hot air moveable head may be configured to move in at least one of an x direction, a y direction, and/or a z direction. Additionally or alternatively, the hot air moveable head may be able to rotate (e.g., 360 degree rotation). In some embodiments, the hot air moveable head may an automated robotic arm (e.g., with the hot air nozzle B2 attached moveable in 5 dimensions). In some embodiments, at least one of the hot air nozzle size or the air flow may be adjustable. For example, the air flow rate and/or air flow velocity may be changed to provide different amount of heat to different portions of the textile material.

Referring now to Block 450 of FIG. 4B, the method of forming the structure of the single layer of textile material with the hot air machine includes removably attaching the textile material to a bottom plate. In various embodiments, the bottom plate is configured with one or more bottom plate inserts configured to receive the textile material. In some embodiments, the textile material is removably attached to the bottom plate via clamps and/or pins. In various embodiments, the textile material may be removably attached to the bottom plate B3 in the same way the textile material may be removably attached to the bottom plate C4 of the molding machine discussed in reference to FIG. 4A above.

Referring now to Block 460 of FIG. 4B, the method of forming the structure of the single layer of textile material with the hot air machine includes selective heat molding the textile material based on the function of the garment. In some embodiments, selectively heated portions of the textile material provide support to the garment. In some embodiments, the selective heat molding the textile material based on the function of the garment comprises: applying hot air, via a hot air nozzle, to specific portions of the textile material. As discussed above, the hot air nozzle B2 may move, via the hot air moveable arm, to various positions on the textile material, such that the hot air nozzle B2 only provides heat to specific zones of the textile material. During operation, the textile garment may be placed on the mold B4. For example, the mold B4 may be used to define the shape of the textile material while heat is being added via the hot air nozzle B2. In various embodiments, the mold B4 may be three dimensional and define the negative of the desired shape of the textile material. In various embodiments, the three-dimensional shape of the textile material may be based on the mold B4. For example, the mold B4 may be made out of clay, wood, or the like.

Referring now to Block 470 of FIG. 4B, the method of forming the structure of the single layer of textile material with the hot air machine includes curing the textile material on mold B4. For example, upon completion of the selective heating (e.g., Block 460), the textile material may remain on the mold B4 in order to cool and maintain the desired shape of the textile material. In various embodiments, the suction beds of the bottom plate B3 may be used to assist the cooling and curing process.

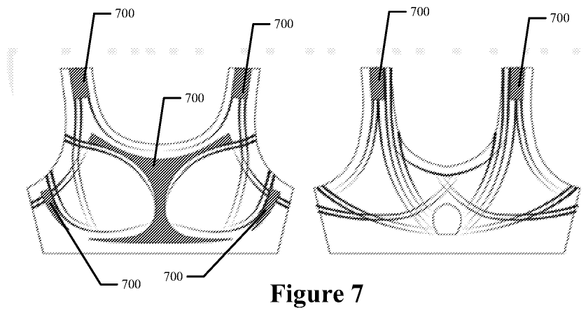

FIG. 7 illustrates the heated portions of a bra garment in accordance with an example embodiment. For example, heat may be applied to the shaded areas. In such an embodiment, the shaded areas 700 experience a locking effect compared with the non-shaded areas. In some embodiments, the locking effect may provide support in order to create a high supportive garment. Various other heating patterns may be contemplated based on the desired support areas of a given garment. The bra garment shown in FIG. 7 may be obtained by any heating process discussed herein (e.g., molding machine and/or robotic hot air machine).

| | Example Method of Present | Example Method of Present |
|---|---|---|
| | Disclosure using Molding | Disclosure using Hot Air |
| Normal Molding Process | Machine | Machine |
| Mounting mold to | Not mounting molds to the | Mounting to the air |
| machine | molding machine but set parallel | suction bed |
| | to molding machine in separate | |
| | chiller unit | |
| Preheating molds prior to | Do not heat mold and are use as is | Use hot air flow |
| molding | without preheating | |
| Clamp to hold the material | Clamp to hold the material prior | Clamp to hold the |
| prior to molding | to molding | material prior to air |
| | | applying |
| Pressed down pre heated | Pick and place the non-heated | |
| mold for molding to crate | molds on to a fabric and press | |
| 3D shape | down to achieve cup depth | |
| Pick the molded panel and | Press down “zonal heated top | Applying air floor by |
| rest for curing on 3D | plate” for thermal pressing | using 5D movable air |
| profile | (approximately 30-60 seconds) to | flow nozzle |
| | be able to lock out the required | |
| | areas of the knitted material | |
| | Pick and replace mold back in | |
| | chiller unit | |
| | Release heated plate back | |
| | Pick the panel and keep for curing | Pick the panel and |
| | on 3D profile | keep for curing on 3D |
| | | profile |

Various embodiments of the present disclosure allow for a single layer garment that allows for support, compression, stretch, modulus, moisture management, hardness, three dimensional shape, defined thickness, and

Although the various embodiments have been illustrated and described herein with reference to preferred embodiments and specific examples thereof, it will be clear to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

Many modifications and other embodiments set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method of manufacturing a single layer garment, the method comprising:
providing a single layer of textile material with low melt yarn; and
forming the structure of the single layer of textile material using selective heating to provide material support.

2. The method of claim 1, wherein the textile material is formed via at least one of a molding machine or a robotic hot air machine.

3. The method of claim 2, wherein the forming of the textile material via the molding machine comprises:
removably attaching the textile material to a bottom plate, wherein the bottom plate is configured with one or more bottom plate inserts configured to receive the textile material;
cold molding the textile material, wherein the cold molding creates the three-dimensional profile of the garment; and
selective heat molding the textile material based on the function of the garment, wherein the selectively heated portions of the textile material provide at least one of fit or support to the garment.

4. The method of claim 3, wherein the textile material is removably attached to the bottom plate via clamps or pins.

5. The method of claim 3, wherein the bottom plate comprises a suction bed configured to pull the textile material into the bottom plate mold.

6. The method of claim 3, wherein the cold molding takes place in an automated chilling unit.

7. The method of claim 3, wherein the selective heat molding the textile material based on the function of the garment comprises: engaging a top plate configured with one or more heated portions with the textile material, wherein the textile material is positioned between the top plate and bottom plate during the hot molding process.

8. The method of claim 2, wherein the forming of the textile material via the hot air machine comprises:
removably attaching the textile material to a bottom plate, wherein the bottom plate is configured with one or more bottom plate inserts configured to receive the textile material;
selective heat molding the textile material based on the function of the garment, wherein the selectively heated portions of the textile material provide support to the garment; and
curing the textile material on a mold.

9. The method of claim 8, wherein the textile material is removably attached to the bottom plate via clamps or pins.

10. The method of claim 8, wherein the selective heat molding the textile material based on the function of the garment comprises: applying hot air, via a hot air nozzle, to specific portions of the textile material.

11. The method of claim 10, wherein the hot air nozzle is operatively coupled to a hot air movable head, wherein the hot air moveable head is configured to move in at least one of an x direction, a y direction, a z direction, or rotationally.

12. The method of claim 10, wherein at least one of the hot air nozzle size or the air flow is adjustable.

13. The method of claim 1, further comprising cutting the garment into a final pattern after the textile material is selectively heated.

14. The method of claim 1, wherein the textile material further comprises a textile yarn and a stretch yarn.

15. The method of claim 1, wherein the textile material is a jacquard material.

16. The method of claim 1, wherein the selective heat is between the melting point of the low melt yarn and the non-low melt yarn.
